(19) United States
(12) Patent Application Publication
(10) Pub. No.: US 2003/0010889 A1
(43) Pub. Date: Jan. 16, 2003

(54) Laser condensing apparatus and laser machining apparatus

(76) Inventors: Yasunori Igasaki, Shizuoka (JP); Satoshi Matsumoto, Shiuzoka (JP)

Correspondence Address: MORGAN LEWIS & BOCKIUS LLP, 1111 PENNSYLVANIA AVENUE NW, WASHINGTON, DC, 20004, US

(21) Appl. No.: 10/203,760

(22) PCT Filed: Feb. 14, 2001
(86) PCT No.: PCT/JP01/01032

(30) Foreign Application Priority Data
Feb. 14, 2000 (JP) 2000-35170

(51) Int. Cl. G01J 1/20

(52) U.S. Cl. 250/201.9

(57) ABSTRACT

A laser condenser 14 comprises a plurality of laser light sources 22, a reflective type spatial light modulator 38 for modulating laser light beams L in order to correct the wavefronts of the respective laser light beams L output from the laser light sources 22, and a condenser lens 40 for condensing the laser light beams L output from the reflective type spatial light modulator 38. The laser light with a wavefront aligned by the reflective type spatial light modulator 38 is condensed by the condenser lens, and thus laser light with a small focal spot and high energy density is obtained.

### TECHNICAL FIELD

The present invention relates to a laser condenser for condensing laser light output from a plurality of laser light sources, and more particularly to a laser condenser used in a laser processing device.

### BACKGROUND ART

From the background art, a semiconductor laser array device described in the publication of Japanese Patent Application Laid-Open H11-17268 is known as a device for condensing laser light output from a plurality of light sources.

The semiconductor laser array device described in this publication comprises a semiconductor laser array constituted by a plurality of semiconductor lasers, a microlens array provided on the laser output side, and a condenser lens for condensing laser light transmitted through the microlens array. The laser light output from the semiconductor array is collimated by the microlens array, and the collimated laser light is condensed by the condenser lens. As an alternative to a condenser lens, the use of a microlens array capable of condensing output laser light from the semiconductor lasers, and also correcting wavefront aberration therein, is also disclosed in this application.

By these means, output laser light from a semiconductor array conventionally used as a YAG laser excimer light source is condensed and caused to directly enter a multimode optical fiber, thereby improving the electrical/optical efficiency and simplifying the configuration of the device.

### DISCLOSURE OF THE INVENTION

However, when laser light from each of the semiconductor lasers constituting the semiconductor laser array is merely condensed, the wavefront of the laser light beams output from the semiconductor laser array does not align perfectly due to mechanical strain or the like in the respective semiconductor lasers, and hence laser light cannot be condensed into one point by the condenser lens, and laser light with a high energy density is not obtained. Moreover, even if there is no mechanical strain among the semiconductor lasers, thus allowing the output of laser light with a perfectly aligned wavefront, the laser light wavefront is affected by changes in the refractive index distribution of the propagation medium, and again it is difficult to condense laser light into one point.

Consequently, it is an object of the present invention to solve the aforementioned problems by providing a laser condenser in which condensed laser light with a small focal spot and high energy density can be obtained, and a laser processing device using this laser condenser.

The laser condenser in accordance with the present invention comprises a plurality of laser light sources, a reflective type spatial light modulator for modulating laser light beams in order to correct the wavefront of laser light output from the light sources, and a condenser lens for condensing the laser light beams output from the reflective type spatial light modulator.

In the present invention, a reflective type spatial light modulator is provided between the plurality of laser light sources and the condenser lens which condenses the laser light output from these light sources. The plurality of laser light beams which enter the reflective type spatial light modulator are individually modulated by this modulator. Thus, the wavefront of the laser light output from the reflective type spatial light modulator can be corrected, and, since the plurality of laser light beams enter the condenser lens, which is provided downstream, with an aligned wavefront, laser light with a small focal spot and high energy density can be obtained.

Particularly, in comparison to a transmission type spatial light modulator, the reflective type spatial light modulator is capable of modulating light of great intensity without damage to the modulator, and hence intense light can be modulated efficiently. Furthermore, this reflective type spatial light modulator is of a phase modulation type which modulates phase in laser light fluxes which are incident on individual compartmental areas (picture elements). A so-called digital micro-mirror device (DMD) may be used as this phase modulation type reflective type spatial light modulator, and phase in the incident light may also be controlled by controlling the amount of irregularity in the mirrors, which are made of a soft film, in each individual picture element. Any reflective type spatial light modulator is capable of adjusting the amount of irregularity in the minute mirrors disposed in each picture element.

The laser light fluxes output from the semiconductor lasers are caused to enter the picture elements on the spatial light modulator such that the wavefronts of the laser light fluxes do not overlap, and the spatial light modulator is controlled such that the wavefronts of the laser light fluxes output from the picture elements, or in other words the phase, are aligned. If these laser light fluxes were to overlap, the wavefront could not be aligned due to the influence of the overlapping laser light fluxes.

The aforementioned laser condenser further comprises a wavefront detector for detecting the wavefront of the laser light output from the laser light sources, and may be characterized in that the wavefront distortion in the laser light beams is detected, and on this basis, the laser light beams are modulated by the reflective type spatial light modulator.

By providing a wavefront detector for detecting the wavefronts of the laser light output from the light sources, the wavefront distortion in the plurality of laser light beams output from the laser light sources is detected, and on the basis of this wavefront distortion, the amount of modulation required for the respective laser light beams can be calculated.

In the aforementioned laser condenser, the plurality of laser light sources comprises a semiconductor laser array consisting of a plurality of semiconductor lasers, and collimating means for collimating the laser light output from the semiconductor lasers. The reflective type spatial light modulator may be disposed in a position in which the laser light beams collimated by the collimating means may become incident on the reflective type spatial light modulator in a mutually separated form. It is preferable that the collimating means be constituted by two cylindrical lens arrays, in which a plurality of cylindrical lenses is installed side by side, disposed such that the directions of installation of the cylindrical lenses are orthogonal to each other.

When such a constitution is employed, the laser light which expands as it is output from the semiconductor lasers may be collimated by the collimating means, the laser light output from the semiconductor lasers may enter the reflective type spatial light modulator, and each laser light may be modulated independently.

The aforementioned laser condenser further comprises a beam splitter, disposed between the semiconductor laser array and the reflective type spatial light modulator, for separating into two directions laser light output from the semiconductor lasers, and is characterized in that the reflective type spatial light modulator is disposed in the direction of advance of one part of the laser light separated by the beam splitter, and at a predetermined spacing from the beam splitter, and the wavefront detector is disposed in the direction of advance of the other part of the laser light separated by the beam splitter, and at a predetermined spacing from the beam splitter.

By using a beam splitter to separate the laser light into two directions, and by disposing the reflective type spatial light modulator and the wavefront detector in positions which are of equal distances from the beam splitter, the wavefront distortion in the laser light beams at the time when the laser light reaches the reflective type spatial light modulator can be detected by the wavefront detector.

The aforementioned laser condenser further comprises a wavefront detector for detecting the wavefronts of the laser light beams output from the reflective type spatial light modulator, and may be characterized in that the reflective type spatial light modulator modulates the laser light beams on the basis of the wavefront distortion in the laser light beams detected by the wavefront detector.

By providing a wavefront detector to detect the wavefronts of the laser light beams output from the reflective type spatial light modulator, wavefront distortion in the plurality of laser light beams output from the reflective type spatial light modulator can be detected, and the amount of modulation required for the laser light beams can be calculated from this wavefront distortion.

The aforementioned laser condenser further comprises detecting means for detecting the dimensions of the focal spot of the laser light condensed by the condenser lens, and maybe characterized in that the reflective type spatial light modulator modulates the laser light beams on the basis of the dimensions of the focal spot detected by the detecting means.

By detecting the dimensions of the focal spot of the laser light which has been condensed by the condenser lens, and by modulating the laser light beams using the reflective type spatial light modulator while monitoring these dimensions, the dimensions of the focal spot maybe adjusted. Here, the dimensions of the focal spot may be detected by a direct detection of the condensed laser light itself, or the dimensions of the focal spot may be detected indirectly.

In the aforementioned laser condenser, the reflective type spatial light modulator employs an optical address method wherein parallel optical information is written by means of an optical system and readout light is modulated and then output, and the reflective type spatial light modulator maybe characterized in that write-in light having a predetermined hologram pattern as the parallel optical information becomes incident thereon. Since write-in light having a hologram pattern enters the reflective type spatial light modulator, the laser light output from the reflective type spatial light modulator and condensed by the condenser lens can be formed into a focal spot with a shape corresponding to the hologram pattern.

The laser processing device in accordance with the present invention is characterized in comprising the aforementioned laser condenser. By comprising the aforementioned laser condenser, laser light with an aligned wavefront can be condensed, whereby laser light with a small focal spot and high energy density can be obtained, and a laser processing device which is effective when working with difficult materials or performing minute processes can be realized.

### BRIEF DESCRIPTION OF THE DRAWINGS

FIG. 1 is a view showing the laser processing device of a first embodiment;

FIG. 2 is a view showing the laser condenser used in the first embodiment;

FIG. 3 is a perspective view of an LD array;

FIG. 4A is a view showing the relationship between the laser light output from the LD array and the microlens array;

FIG. 4B is an enlarged view of one part of the microlens array 32;

FIG. 5 is a view showing the construction of a reflective type spatial light modulator;

FIG. 6 is a view showing the laser condenser used in a second embodiment;

FIG. 7 is a view showing the laser processing device of a third embodiment;

FIG. 8 is a view showing the laser condenser used in the third embodiment; and

FIG. 9 is a view showing the relationship between the laser light output from the LD array and the microlens array.

### BEST MODES FOR CARRYING OUT THE INVENTION

Preferred embodiments of the laser processing device and laser condenser used therein in accordance with the present invention will be described in detail below together with the drawings. Note that identical elements will be allotted identical symbols and redundant explanations will be omitted.

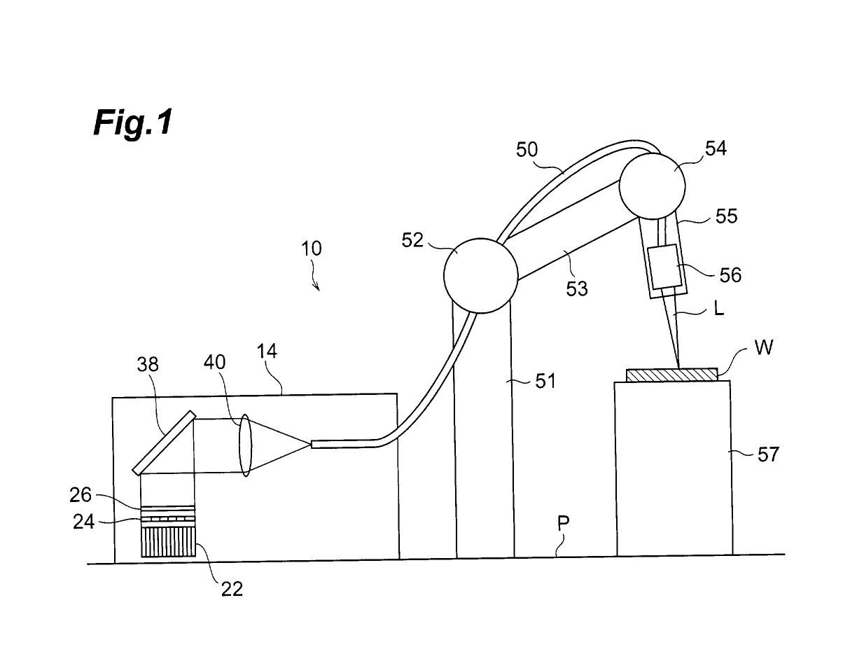

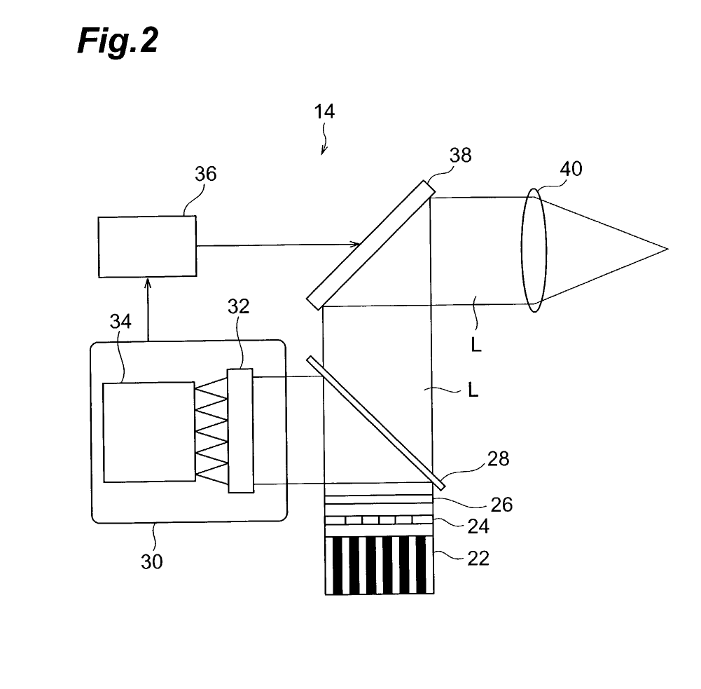

FIG. 1 is a view showing the laser processing device 10 which uses the laser condenser 14 in accordance with the first embodiment. The laser processing device 10 comprises a laser condenser 14 (the construction of which will be described in detail below with reference to FIG. 2) for condensing and then outputting laser light L which is output from a plurality of light sources, an optical fiber 50 for transmitting the laser light L which has been condensed by the laser condenser 14, and an output optical section 56 for outputting the transmitted laser light L onto an object to be processed W.

The arm part of the laser processing device 10 which supports the optical fiber 50 will now be explained. The arm part is constituted by a support post 51 which is fixed to a reference plane P, a first driving arm 53 which is supported by a first driving section 52 so as to be free to rotate with respect to the support post 51, and a second driving arm 55 which is supported by a second driving section 54 so as to be free to rotate with respect to the first driving arm 53.

The output optical section 56 is equipped with an output lens (not shown), and is capable of condensing laser light L that is transmitted from the optical fiber 50 and outputting this light onto the object to be processed W. This output optical section 56 is provided at the end of the second driving arm 55, and therefore by operating the first driving arm 53 and second driving arm 55, the direction of the laser light L and the position of irradiation onto the object to be processed W, which is placed on a workbench 57, can be altered.

The laser condenser 14 which is a feature of this embodiment will now be explained. FIG. 2 is a view showing the laser condenser 14 of the first embodiment. The laser condenser 14 comprises a laser diode array (hereafter referred to as “LD array”) 22, which is a plurality of laser light sources, two cylindrical lens arrays 24 and 26, provided on the output side of the LD array 22, a reflective type spatial light modulator (hereafter referred to as “SLM”) 38, disposed at a 45° incline with respect to the optical axis of the laser light L that is output from the LD array 22, and an aspherical lens 40, which is a condenser lens disposed on the optical axis of the laser light L that is output from the SLM 38.

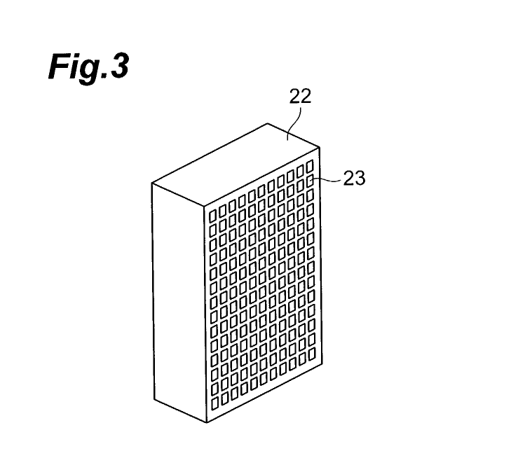

FIG. 2 is drawn two-dimensionally, but in actuality a plurality of laser diodes 23 is disposed three-dimensionally in the LD array 22, as shown in FIG. 3. The cylindrical lens arrays 24 and 26 are constituted by a plurality of cylindrical lenses installed side by side. The two cylindrical arrays 24 and 26 are disposed such that the directions of installation of the cylindrical lenses are orthogonal to each other, and the laser light beams L, which expand in a conical fashion when output from the laser diodes 23 of the LD array 22, are collimated in a horizontal direction by one of the cylindrical lens arrays 24, and collimated in a vertical direction by the other cylindrical lens array 26. The SLM 38 is disposed in a position which is removed to the extent that the laser light beams L which are collimated by the two cylindrical lens arrays 24 and 26 expand but do not overlap.

A beam splitter 28 is disposed between the cylindrical lens array 26 and the SLM 38 at a 45° incline with respect to the laser optical axis, and a Shack-Hartmann sensor 30, which is a wavefront detector, is disposed on the optical axis of the branched laser light L which is bent into a right angle by the beam splitter 28. Here, the Shack-Hartmann sensor 30 is disposed in a position in which the optical distance between the Shack-Hartmann sensor 30 and the beam splitter 28, and the optical distance between the SLM 38 and the beam splitter 28 are equal. Furthermore, the Shack-Hartmann sensor 30 is connected to an SLM controller 36 for controlling the modulation amount of the SLM 38.

As illustrated in FIG. 2, the Shack-Hartmann sensor 30 is constituted by a microlens array 32 and a CCD camera 34.

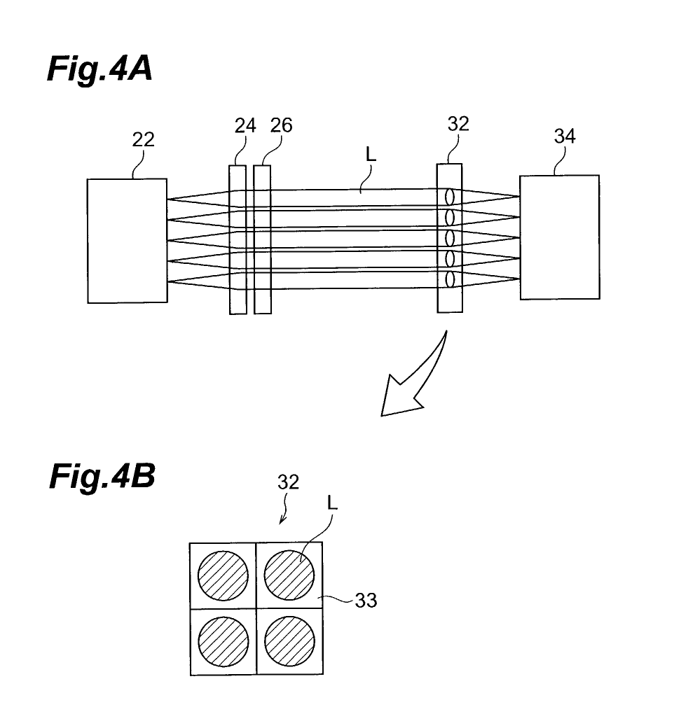

FIG. 4A is an explanatory view to explain the relationship between the laser light L output from the LD array 22 and the microlens array 32, and FIG. 4B is an enlarged view showing an enlargement of one part of the microlens array 32.

As is illustrated in FIG. 4A, the laser light beams L which have been collimated by the cylindrical lens arrays 24 and 26 reach the microlens array 32 in a state of separation, and, as illustrated in FIG. 4B, enter the lens elements 33 of the microlens array 32 and are each condensed therein. As can be seen from FIG. 4B, the respective laser light beams L correspond to the respective lens elements 33 of the microlens array 32. Then, taking advantage of the fact that the misalignment in the focal point position of the laser light beams L condensed by the lens elements 33 is proportionate to the wavefront distortion of the laser light beams L, the wavefront distortion of each of the laser light beams L is detected.

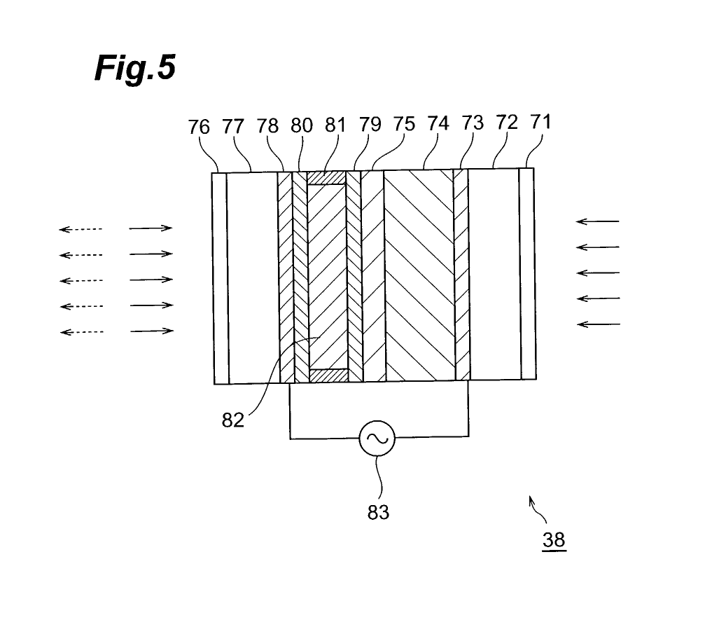

The SLM 38 will now be described with reference to FIG. 5. The SLM 38 comprises a glass substrate 72 which is coated on the write-in light entrance surface with an AR coat 71 to prevent the unnecessary reflection of write-in light. Further, a photoconductive layer 74 consisting of amorphous silicon (α-Si), in which resistance is altered corresponding to the intensity of the incident light that enters via a transparent electrode 73, and a mirror layer 75 manufactured from a dielectric multilayer film, are laminated together on the entrance surface of this glass substrate 72 and the surface on the opposite side thereto.

The SLM 38 further comprises a glass substrate 77, likewise coated with an AR coat 76 on the readout light entrance surface. A transparent electrode 78 is laminated onto the entrance surface of this glass substrate 77 and the surface on the opposite side thereto, and orientation layers 79 and 80 are provided on the aforementioned mirror layer 75 and transparent electrode 78 respectively. These orientation layers are mutually opposed and connected via a frame-shaped spacer 81, and a liquid crystal layer filled with nematic liquid crystal is provided within the frame of the spacer 81 to form an optical modulation layer 82. By means of the orientation layers 79 and 80, the nematic liquid crystal inside the optical modulation layer 82 is oriented in parallel or perpendicular to the surface of the orientation layers 79 and 80. A driving device 83 is connected between the two transparent electrodes 73 and 78 in order to apply a predetermined voltage.

Write-in light from the SLM controller 36 enters the entrance surface on the write-in light side of the thus constructed SLM 38, whereby optical modulation is performed. In other words, the SLM controller 36 produces write-in light for the SLM 38 on the basis of the wavefront distortion in the laser light beams L, which is detected by the Shack-Hartmann sensor 30. When this write-in light becomes incident from the photoconductive layer 74 side, the electrical resistance drops in the part of the photoconducitve layer 74 upon which light is incident, whereby a voltage is applied to the optical modulation layer 82 to alter the orientation of the liquid crystal which constitutes the optical modulation layer 82. Thus, the laser light L that is transmitted through the optical modulation layer 82 is modulated. Write-in light is controlled on the basis of the wavefront distortion in the laser light beams L, which is detected by the Shack-Hartmann sensor 30, and thereby, the wavefront of the laser light beams L that are output from the LD array 22 to enter the SLM 38 can be aligned.

Particularly, in comparison to a transmission type SLM, the reflective type SLM 38 is capable of modulating light of great intensity without damage to the modulator, and hence intense light can be modulated efficiently. Furthermore, this reflective type SLM 38 is of a phase modulation type for modulating phase in laser light fluxes which are incident on individual compartmental areas (picture elements). A so-called Digital Micro-mirror Device (DMD) may be used as this phase modulation type reflective type SLM, and phase in the incident light may also be controlled by controlling the amount of irregularity of the mirrors, which are made of a soft film, in each individual picture element. Any reflective type SLM can adjust the amount of irregularity in the minute mirrors disposed in each picture element.

The laser light fluxes output from the semiconductor lasers are caused to enter the picture elements on the SLM 38 such that the wavefronts of these laser light fluxes do not overlap, and the SLM 38 is controlled such that the wavefronts of the laser light fluxes output from the picture elements, or in other words the phase, are aligned. If the laser light fluxes were to overlap, the wavefront could not be aligned due to the influence of the overlapping laser light fluxes.

The operations of the laser processing device 10 of this embodiment will now be explained. First, a plurality of laser light beams L are output from the LD array 22. These output laser light beams L are collimated by the two cylindrical lens arrays 24 and 26, thereafter entering the beam splitter 28 and being branched into two directions by the beam splitter 28.

The laser light beams L that are transmitted through the beam splitter 28 enter the SLM 38. On the other hand, the laser light beams L that are reflected by the beam splitter 28 enter the Shack-Hartmann sensor 30. To explain this in detail, the laser light beams L enter the microlens array 32 which constitutes the Shack-Hartmann sensor 30, and each of the laser light beams L is condensed by the respective lens elements 33 of the microlens array 32 so as to enter the CCD camera 34 (see FIG. 4A). Here, the focal point position of the laser light L, which has been condensed by each of the lens elements 33, is measured by the CCD camera 34, and on the basis of the misalignment in the focal point position, the wavefront distortion in the laser light beamms L is detected.

Information about the wavefront distortion-in the laser light beams L which is detected in the aforementioned manner, is transmitted to the SLM controller 36. In the SLM controller 36, the write-in light to be irradiated onto the SLM 38 is controlled on the basis of this wavefront distortion information, and the wavefront of the laser light beams L output from the SLM 38 is corrected. To describe this in more detail, the plurality of laser light beams L, which are output from the LD array 22 to enter the SLM 38, are collimated by the cylindrical lens arrays 24 and 26, whereby adjacent laser light beams L are separated. Accordingly, by altering the orientation of the areas of the optical modulation layer 82 upon which the laser light beams L are incident, each laser light beam L can be individually modulated, and the wavefront of the laser light beams L can be securely corrected.

The laser light L, the wavefront of which has been corrected in the SLM 38, is output toward the aspherical lens 40, and the laser light L that is incident on the aspherical lens 40 is condensed at the focal point of the aspherical lens 40. Then, the condensed laser light L is transmitted to the output optical section 56 via the optical fiber 50, and the laser light L is output from the output optical section 56 shown in FIG. 1 to the object to be processed W, whereupon laser processing such as welding or drilling is performed.

In the laser condenser 14 of this embodiment, the cylindrical lens arrays 24 and 26 are disposed on the output side of the LD array 22 and collimate the output laser light L from the LD array 22 such that a plurality of laser light beams L enter the SLM 38 in a separated state. Thereby, modulation can be conducted on an individual basis for each of the laser light beams L in the SLM 38, and hence, the wavefront of the laser light beams L can be securely aligned.

Furthermore, the aspherical lens 40 is disposed downstream of the SLM 38, and thus the wavefronts of the laser light beams L which enter the aspherical lens 40 have already been aligned by the SLM 38. Thereby, the laser light beams L that are condensed by the aspherical lens 40 come to have a small focal spot and high energy density. To explain more specifically, according to this embodiment, the focal spot can be made in the order of millimeters or less.

Furthermore in this embodiment, the wavefront distortion in the laser light beams L output from the LD array 22 is detected and the laser light L is modulated on the basis of this wavefront distortion in the SLM 38. Thereby, the wavefronts of the laser light beas L can be securely aligned even when the characteristics of the laser diodes 23 change due to time dependent changes in the LD array 22, or when the medium refractive index between the LD array 22 and the SLM 38 changes.

Since the laser processing device 10 of this embodiment comprises the laser condenser 14 having the aforementioned effects, high energy density laser light L can be irradiated onto the object to be processed W, and processing can be performed efficiently.

The laser processing device 10 of the second embodiment of the present invention will now be explained. The laser processing device 10 of the second embodiment has the same basic structure as the laser processing device 10 of the first embodiment, but the structure of the laser condenser 16 is different.

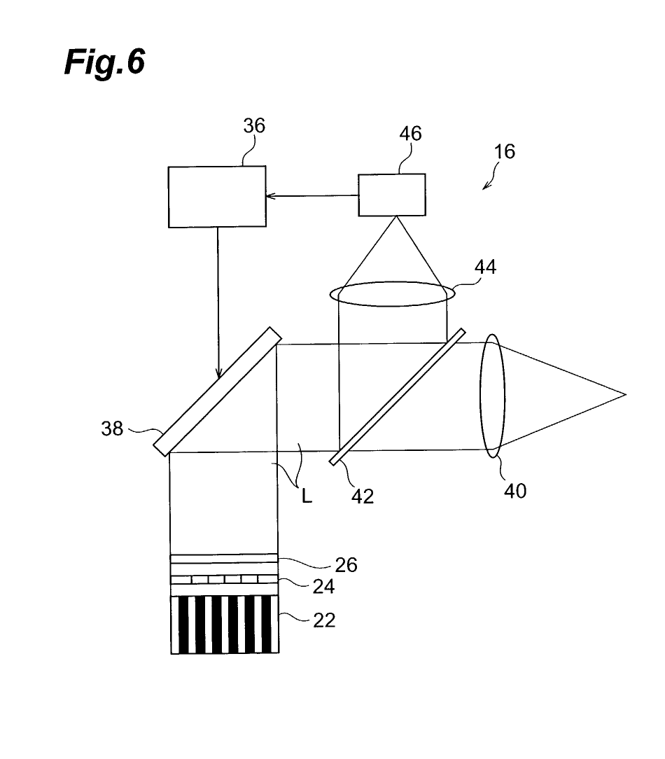

The laser condenser 16 of the second embodiment will be explained with reference to FIG. 6.

In the laser condenser 16 of the second embodiment, similarly to the laser condenser 14 of the first embodiment, an LD array 22, cylindrical lens arrays 24 and 26, an SLM 38, and an aspherical lens 40 are disposed. Abeam splitter 42 is also provided between the SLM 38 and the aspherical lens 40 at an incline of 45° with respect to the optical axis of the output laser light L which is output from the SLM 38.

A second aspherical lens 44 with the same specifications as the aforementioned aspherical lens 40 is disposed on the optical axis of the branched laser light L which has been bent into a right angle by the beam splitter 42, and a CCD camera 46 connected to the SLM controller 36 is disposed at the focal point position of this second aspherical lens 44. Here, the second aspherical lens 44 is disposed such that the optical distance between the asherical lens 40 and the beam splitter 42, and the optical distance between the second asherical lens 44 and the beam splitter 42 are equal. The second asherical lens 44 and CCD camera 46 constitute the detecting means for detecting the focal spot of the laser light L which has been condensed by the asherical lens 40.

The operations of the laser condenser 16 which is a feature of the second embodiment will now be explained. First, a plurality of laser light beams L is output from the LD array 22. The output laser light beams L are collimated by the cylindrical lens arrays 24 and 26, and then enter the SLM 38 to be modulated in accordance with the control of the SLM controller 36. The laser light L which is output from the SLM 38 is branched into two directions by the beam splitter 42, which is disposed on the optical axis of the laser light L.

The laser light L that is reflected by the beam splitter 42 is condensed in the second aspherical lens 44 and enters the CCD camera 46. The CCD camera 46 monitors the focal spot of the condensed laser light L, and the SLM controller 36 controls the SLM 38 based on the dimensions of this focal spot. It is desirable here that control be performed such that the focal spot is made smaller. On the other hand, the laser light L that is transmitted through the beam splitter 42 is condensed by the aspherical lens 40.

In the laser condenser 16 of the second embodiment, the laser light L output from the SLM 38 is separated in the beam splitter 42; the second aspherical lens 44, which has the same specifications as the aspherical lens 40, is disposed in a position with the same optical distance to the beam splitter 42 as the aspherical lens 40, and the focal spot of the laser light L which is condensed by the second aspherical lens 44 is measured by the CCD camera 46. This focal spot is the same as the focal spot formed by the aspherical lens 40, and hence the monitoring of the focal spot by the second aspherical lens 44 is substantially the same as the monitoring of the focal spot by the aspherical lens 40. If the SLM 38 is controlled such that this focal spot becomes small, then laser light L with a small focal spot and high energy density can be securely obtained.

The laser processing device 12 of the third embodiment of the present invention will now be explained.

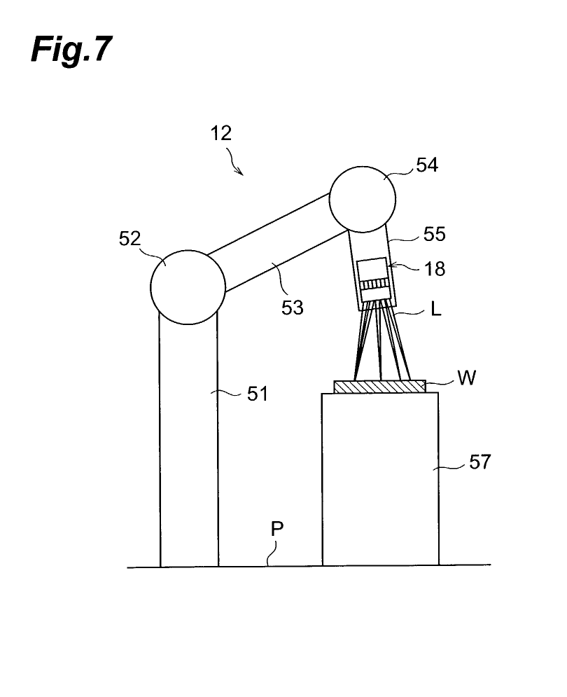

FIG. 7 is a view showing the laser processing device 12 of the third embodiment. The laser processing device 12 has a second driving arm 55 for changing the position of irradiation and direction of the laser light L onto the object to be processed W which is placed on the workbench 57. This second driving arm 55 is equipped with a laser condenser 18 (drawn in frame format in FIG. 7) which is provided thereon in order to condense and output laser light L output from a plurality of light sources.

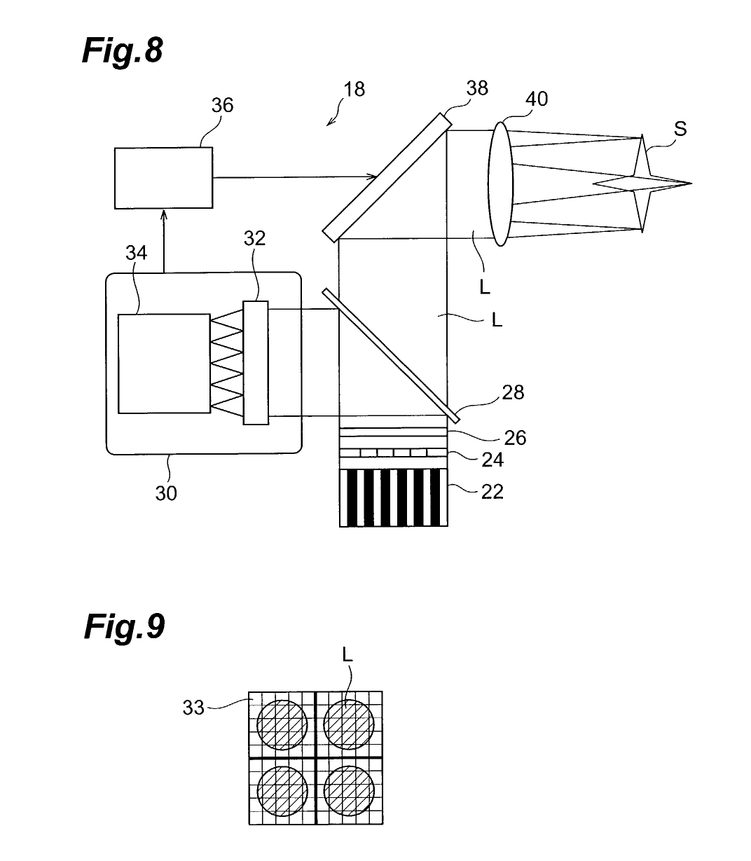

The laser condenser 18 which is a feature of the third embodiment will now be explained. FIG. 8 is a view showing the laser condenser 18 of this embodiment. The laser condenser 18 of this embodiment has the same basic structure as the laser condenser 14 of the first embodiment, but differs in that a predetermined hologram pattern is formed in the write-in light which is incident from the SLM controller 36.

Since a predetermined hologram pattern is formed in the write-in light which is inputted to the SLM 38 from the SLM controller 36, the laser light L output from the SLM 38 is condensed by the aspherical lens 40 to form a focal spot S with a shape corresponding to the hologram pattern. For example, a cross-shaped focal spot, such as that shown in FIG. 8, may be obtained.

Further, since the laser processing device 12 of this embodiment is equipped with the laser condenser 18, the object to be processed W may be easily processed into any form during processing. For example, when drilling to a pattern determined in advance, there is no need to scan the laser light L, and thus the manufacturing time may be compressed. Also, a number of points may be processed simultaneously. Moreover, by modifying the hologram pattern output from the SLM controller 36, various types of processing may be performed easily.

Embodiments of the present invention were explained in detail above. However, the present invention is not limited to the aforementioned embodiments.

In the aforementioned first embodiment, a Shack-Hartmann sensor 30 is provided between the cylindrical lens arrays 24 and 26 and the SLM 38, but may also be provided between the SLM 38 and the aspherical lens 40. By means of such a constitution, the wavefront distortion in the laser light beams L output from the SLM 38 is detected, and feedback control can be performed by the SLM controller to align the wavefront. In so doing, the wavefront of the laser light L output from the SLM 38 can be securely aligned.

In the aforementioned embodiments, in the present embodiment an SLM 38 using an optical address method, which is a method in which parallel information is written into address material, was described, but the write-in method may also be an electrical address method.

Further, in the microlens array used in the Shack-Hartmann sensor 30 of the first embodiment, one lens element corresponds to one laser light beam L. However, one laser light beam L may be condensed by a plurality of lens elements. For example, as shown in FIG. 9, it is acceptable if one laser light beam L is divided into 25 compartments and condensed by the lens elements 33 provided in those compartments. With this constitution, more detailed wavefront information can be obtained, and the wavefront of the laser light L can be aligned with finer precision.

According to the present invention, a reflective type spatial light modulator is disposed in front of the condenser lens for condensing laser light, and when the wavefront of the laser light output from the plurality of light sources has been aligned, the laser light is condensed. Thus, laser light with a small focal spot and high energy density can be obtained.

Further, in the present invention, wavefront distortion in the laser light output from the light sources is detected, and the laser light is modulated by the reflective type spatial light modulator on the basis of this wavefront distortion. Hence the laser light wavefront can be aligned and the laser light condensed at any time without any influence from time dependent changes in the light sources, changes in the medium refractive index of the laser light, and so on.

### INDUSTRIAL APPLICABILITY

The present invention may be used in a laser condenser for condensing laser light output from a plurality of laser light sources, and particularly in a laser processing device.

1. A laser condenser comprising:
a plurality of laser light sources;
a reflective type spatial light modulator for modulating laser light beams in order to correct the wavefront of laser light output from said light sources; and
a condenser lens for condensing said laser light beams output from said reflective type spatial light modulator.

2. The laser condenser according to claim 1, further comprising a wavefront detector for detecting the wavefront of the laser light output from said laser light sources, wherein said reflective type spatial light modulator modulates said laser light beams on the basis of the wavefront distortion in the laser light beams, which is detected by said wavefront detector.

3. The laser condenser according to claim 1, wherein said plurality of laser light sources comprises:
a semiconductor laser array comprised of a plurality of semiconductor lasers; and
collimating means for collimating laser light output from the semiconductor lasers, and
wherein said reflective type spatial light modulator is disposed in a position in which the laser light collimated by said collimating means may become is incident on said reflective type spatial light modulator in a separated form.

4. The laser condenser according to claim 3, wherein said collimating means are constituted by two cylindrical lens arrays, in which a plurality of cylindrical lenses is installed side by side, said cylindrical lens arrays being disposed such that the directions of installation of the cylindrical lenses are orthogonal to each other.

5. The laser condenser according to claim 3, further comprising a beam splitter disposed between said semiconductor laser array and said reflective type spatial light modulator, for separating into two directions laser light output from said semiconductor lasers, wherein said reflective type spatial light modulator is disposed in the direction of advance of one part of the laser light separated by said beam splitter, at a predetermined spacing from said beam splitter, and said wavefront detector is disposed in the direction of advance of the other part of the laser light separated by said beam splitter, at a predetermined spacing from said beam splitter.

6. The laser condenser according to claim 1, further comprising a wavefront detector for detecting the wavefronts of the laser light beams output from said reflective type spatial light modulator, wherein said reflective type spatial light modulator modulates said laser light beams on the basis of the wavefront distortion in the laser light, which is detected by said wavefront detector.

7. The laser condenser according to claim 1, further comprising detecting means for detecting the dimensions of the focal spot of the laser light condensed by said condenser lens, wherein said reflective type spatial light modulator modulates said laser light beams on the basis of the dimensions of the focal spot detected by said detecting means.

8. The laser condenser according to claim 1, wherein said reflective type spatial light modulator employs an optical address method, wherein parallel optical information is written by means of an optical system whereby readout light is modulated and output, and write-in light having a predetermined hologram pattern as said parallel optical information becomes incident on said reflective type spatial light modulator.

9. A laser processing device comprising the laser condenser according to claim 1.

10. A laser condenser which modulates a plurality of laser light fluxes output respectively from a plurality of light sources and then condenses these laser light beams.
